(19) United States
(12) Patent Application Publication
(10) Pub. No.: US 2005/0283398 A1
(43) Pub. Date: Dec. 22, 2005

(54) Method and arrangement for exploiting user feedback during product start-up

(76) Inventors: Antti Hintikka, Haukipudas (FI); Esko Alasaarela, Oulu (FI)

Correspondence Address: YOUNG & THOMPSON, 745 SOUTH 23RD STREET, 2ND FLOOR, ARLINGTON, VA, 22202, US

(21) Appl. No.: 11/144,794

(22) Filed: Jun. 6, 2005

Related U.S. Application Data
(63) Continuation of application No. PCT/FI03/00926, filed on Dec. 4, 2003.

(30) Foreign Application Priority Data
Dec. 4, 2002 (FI) 20022143

(51) Int. Cl. G06F 17/60

(52) U.S. Cl. 705/11

(57) ABSTRACT

The present invention relates to a method, an arrangement and a cellular network terminal with which it is possible to gather and analyze customer feedback received about a product or service. A user provides feedback by utilizing a two-dimensional evaluation field (31), which is presentable on a graphical display. The provided feedback is transferred via a data transmission network (20) into a product/service provider's database (22). The information in said database (22) is analyzed in real time, so that possible corrective measures can be initiated immediately when a problem appears.

### CROSS REFERENCE TO RELATED APPLICATIONS

This application is a continuation of International Application No. PCT/F12003/000926, filed on Dec. 4, 2003, which designated the United States, the entire contents of which are hereby incorporated by reference.

The present invention relates to a method for producing real-time user feedback about a product or service, in which method a user provides his feedback on a two-dimensional evaluation field. The present invention also relates to a feedback arrangement, which comprises a two-dimensional evaluation field for providing feedback about a product/service, means for analyzing said feedback, a data transmission network and means for combining the product/service and the feedback analysis means in the data transmission network. The present invention also relates to a cellular network terminal capable of exploiting said method.

Customer feedback about the operation and functionality of different kinds of devices, such as mobile phones, is vitally important to device suppliers and service-providing operators. Yet, feedback systems of the prior art are not sufficiently swift, for example, in conjunction with the start-up of a new product or the release of a new product feature. Feedback obtained using said systems is not obtained quickly enough to allow product development to react already during the first hours that a new product is on the market.

Feedback systems of the prior art require effort and time from the customer. If the customer is not willing to put in his time to provide feedback, valuable feedback which could be exploited in eliminating problems contained in a product or as a basis for further development of a product, is not obtained. Often this type of feedback questionnaire, in which the customer does evaluation work, has an irritating effect on the customer. The customer may possibly have to fill out complicated forms or computerized questionnaires or he may possibly be disturbed by a telephone survey. This all may have the effect of lowering customer satisfaction.

The life cycle of a product may also be quite short, perhaps only a few months to a year, before said product is replaced by another product. With a slow feedback system, regardless of what kind it is, information about a product is not obtained until the product is already in the declining phase of its life cycle. In such a situation the obtained information is not very significant from the standpoint of said product. The quicker user-specific feedback about a product is obtained, the better are a manufacturer's or service provider's possibilities of repairing or improving their product/service already during the initial phases of the product's life cycle.

It is also very common for customer feedback systems to be typically taken into use only in a problem situation, whereupon feedback about reasonably well or well-functioning products and product features is not obtained at all. Therefore, feedback is often random and the sample obtained as feedback does not provide product development with a systematic or sufficient picture of the quality or popularity of a product or service. Important signals depicting customers' emotions thus remain unexploited. However, because the next purchasing decision is often based on emotions, said signals of emotions are very significant to the further development of a product or service.

Often in product development programs there is a desire to reward good/very good performance. A typical problem in rewarding in conjunction with product programs is that meters which measure the goodness of a product provide results only in the middle or final phases of a product's life cycle, which in turn results in difficult delays in specifying and measuring incentive rewards. Many years of delay in receiving an incentive reward is not sensible from the standpoint of providing feedback.

From patent publication PCT/FI01/00300 is known a method and arrangement operating somewhere in a data transmission network, by which means it is possible to gather operating or evaluation results from a specific group as a two or three-dimensional output. Said process and arrangement are hereinafter referred to as ZEF (said publication refers to the ZEF method and arrangement as CREST).

The operation of the ZEF method and arrangement is based on collecting evaluation information in two or three-dimensional form (e.g., importance/success), for example by exploiting a fourfold table, which in itself is known. In the ZEF method the evaluation results of an individual evaluator are standardized evaluator—specifically in such a way that the mean value of points entered by an evaluator into a fourfold table falls on the origin, and the deviation (standard deviation or some other value depicting the deviation of the evaluation) coincides with a fixed value decided in conjunction with the specification of the study.

Said first standardization eliminates irregularity in the evaluator's personal attitude. In someone's opinion all the evaluated features are important, while others feel they are not. Some feel everything goes badly, while someone else sees both good and bad aspects. In both cases, by means of said standardization the relative position of the evaluations of both with respect to the set of all the features they evaluated can be determined from the responses.

When a sufficient number of evaluations provided by different evaluators has been obtained or when a possible deadline specified for evaluations is reached, a summation is calculated and a second standardization is performed. The position of each evaluated feature is calculated as the mean of the positions provided by all the evaluators. Means and standard deviations are calculated separately in each dimension used as an evaluation axis. The new positions of the points are standardized a second time in such a way that the aggregate mean of all the points again falls on the origin of the summation fourfold table and the aggregate standard deviation of all the points falls in each direction on the originally specified fixed value (e.g., on one when using a 1.5×1.5 table). The standard deviation of the position of each evaluation point (the deviation of the positions given by the evaluators) can be output as an ellipse, a polyhedron or some other two-dimensional figure (two-dimensional table) or a corresponding three-dimensional figure (three-dimensional table) drawn around said point. When, for example, an ellipse is used, the major axes of said ellipse depict the deviation in each direction of the points given by the evaluators (e.g., major axis=standard deviation).

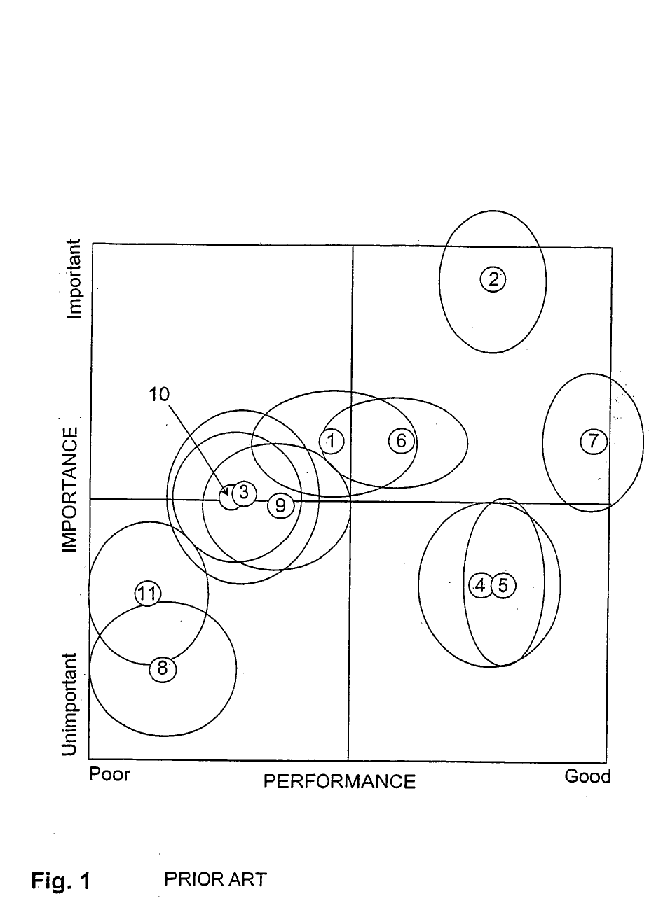

From the end result it is possible to see at a glance which of the evaluated features fall in each of the fields of the summation fourfold table (or the section of the cube bordered by the coordinates). FIG. 1 contains an exemplary presentation of what a summation table looks like after a second standardization according to the ZEF method. In the example presented in FIG. 1, eleven separate evaluation points, with reference numbers 1-11, have been evaluated. In the example presented in FIG. 1, good and important features in the importance/performance fourfold field are distinguishable from poor and unimportant features. It can be immediately seen from the shape of the ellipse associated with each evaluation point in which matters the evaluators were in agreement and in which matters they had a different opinion.

If the ZEF fourfold table used in the evaluation and needed by the evaluator exists, the evaluation may happen very quickly even though the evaluated persons were physically in different parts of the world. It is possible to make the result visible to all the evaluators and other desired persons, in which case discussion gets new stimuli and causes matters to be thought of in a similar vein. Said ZEF fourfold table results may also be exploited to support product development. Likewise, regular monthly or yearly monitoring is possible if the results of the evaluations are stored and they are output combined in one diagram.

Gathering of evaluation information happens most advantageously through an information network interface, where each evaluator is shown his own input table, where the features being evaluated or other matters are listed and numbered and where the evaluator uses a mouse or similar means to move numbers to the desired positions in his own table. The axes of the evaluation table, which may be two or three-dimensional, depict the evaluated characteristics/dimensions (e.g., “importance” on the vertical axis and “performance” on the horizontal axis). The poor value of said dimensions is located at one end of the axes and the strong/good value at the opposite end (e.g., unimportant/important, poor/good performance).

The evaluation information may also be gathered as numerical values or by checkmarking boxes. In such a case there may be more than three dimensions. Evaluation using numbers becomes advantageous when a graphical web browser equipped with special features is not available or if the values are given by email, fax, telephone or by means of a GSM, WAP or GPRS terminal.

Nevertheless, also the ZEF method presented above requires someone to organize the evaluation of the features. Said organizing person needs to specify at least what is to be evaluated, select the data transmission means/networks used in the evaluation, choose and recruit suitable evaluators and specify the evaluation timetable. All of this planning and evaluation work consumes time. Therefore, application of the ZEF method presented above is not easy in a user study in which the users cannot be chosen or trained or if the study needs to be completed quickly in conjunction with a product release.

Thus, there continues to be a need for a method and arrangement that supports product development, by which it is possible during the first hours following the introduction of a product to the market, to quickly/immediately obtain authentic, analyzed feedback to support further product development quickly and without irritating the ordinary product user.

The purpose of the present invention is to present a method and arrangement which makes it possible to obtain analyzed feedback for the product development activity of a product/service developer from the user experiences of ordinary users of a product/service immediately after said product has entered the market.

The purposes of the present invention are achieved by means of a method and arrangement in which a specific user, after using a new product or service the first time or the first few times, upon closing/ending the use of his device or the exploitation of a service, advantageously may at the same time present his evaluation of the functionality of certain functions of the device/service by means of a two-dimensional evaluation fourfold table, which is stored in a purchased device or an automated means that produces a service. The evaluation fourfold table appears automatically when use of the device or service is being terminated. The evaluation is sent to the information system of a manufacturer/service provider for actual analysis without separate actions performed by the user. This way information about the functionality of the product/service is obtained immediately to support product development as soon as the first product units are sold or immediately when a new functional feature is taken into use, for example in conjunction with a software update.

A feedback method according to the present invention is characterized in that an at least two-dimensional evaluation field employed therein becomes activated in a device utilized by a user upon fulfillment of a specific criterion of use, and feedback on said two-dimensional evaluation field is transferred via a data transmission network into a product/service provider's database for completion of a feedback analysis.

A feedback arrangement according to the present invention is characterized in that an at least two-dimensional evaluation field employed therein is realized with software means contained in a product/service, which means are arranged to become activated in a device/service utilized by a user upon fulfillment of a specific criterion of use, and feedback on said at least two-dimensional evaluation field is arranged to be transferred via a data transmission network into a product/service provider's means of analyzing feedback information for completion of feedback analysis.

A cellular network terminal according to the present invention is characterized in that it comprises means for activating and conducting an at least two-dimensional feedback questionnaire and for sending information into a specific database upon fulfillment of a specific criterion of use.

Certain advantageous embodiments of the present invention are presented in the dependent claims.

The basic principle of the present invention is as follows: A possibility to provide feedback on, for example, a ZEF tool's 2D or 3D evaluation field, is coupled to a product being manufactured or to a service being provided. The evaluation field becomes activated when use of the product or use of the service is being terminated in a customary manner. The evaluation field according to the present invention may open either during the first session of use only or during the first few sessions of use or at intervals between specified numbers of sessions of use or whenever the user desires. Before the product/device or service that is being used enters a rest mode, the user is offered a possibility to provide his evaluation of the product's functionality by means of a graphical evaluation field contained in the device. The evaluation field may be in the product/device itself or the product/device may connect itself, for example, via a Bluetooth or infrared connection, to a second device containing an accessible graphical user interface. After the user has given his evaluation the product/device and a possible second device enter the rest mode only after the feedback/evaluation is sent via a data transmission network into the product/device manufacturer's or service provider's information system. A second phase of the analysis according to the present invention is completed in the information system. In the second analysis phase the received feedback is advantageously further categorized by user group, if such information is available. This is possible, for example, in cases where a device or service is connected to a data communication network. By means of this method user information can be gathered and analyzed immediately after users have used a specific product/device or service the first times.

One advantage of the present invention is that feedback obtained about experience in using a new product or service can be obtained in real time and it can also be analyzed in real time.

Another advantage of the present invention is that, based on the received user feedback, it is possible to initiate corrective measures that are possibly deemed necessary on the basis of the analysis already on the strength of the feedback received from the first users, and not only after several days or weeks have passed or after a possible interview survey has been conducted.

Another advantage of the present invention is that after the critical initial feedback about the product/service it is possible to interrupt the start-up of the product before it damages the image of the company.

Another advantage of the present invention is that the first user experiences with new product updates can be obtained in real time.

Another advantage of the present invention is that feedback obtained about user experience with a product can be obtained, if necessary, over the entire life cycle of a product/device/service.

Another advantage of the present invention is that by means of the received feedback it is possible to focus marketing effort correctly.

Still another advantage of the present invention is that the success of a product development process can be evaluated quickly after a product/service has entered the market, whereupon possible incentives or rewards related to development activity in a well executed development project are easy to specify.

The present invention is described in detail below, with reference to the enclosed drawings, where

FIG. 1 shows an exemplary presentation of a summation fourfold table of the ZEF process

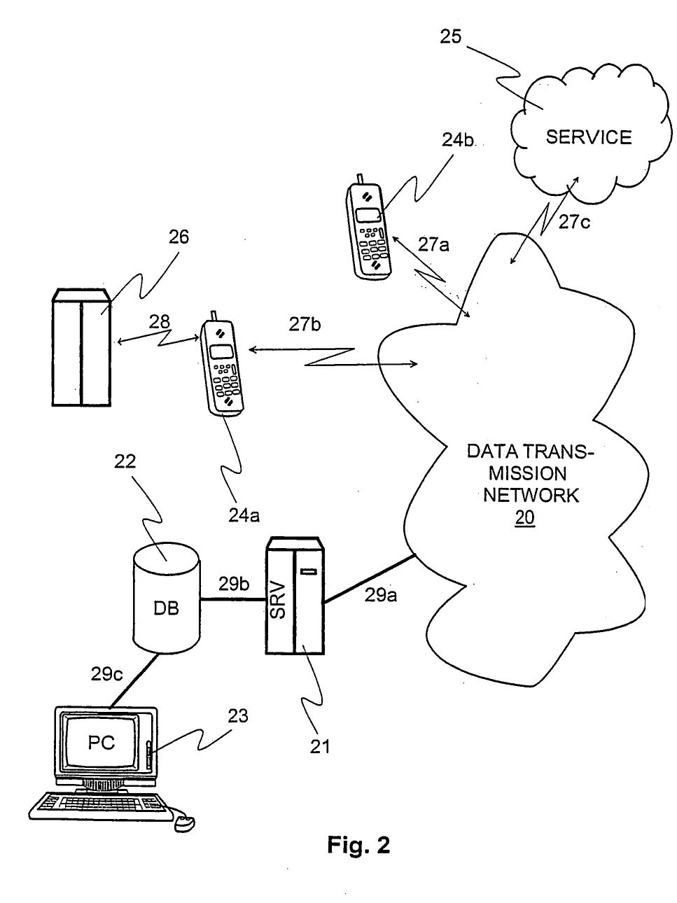

FIG. 2 shows an exemplary presentation of a network arrangement enabling operation according to the present invention

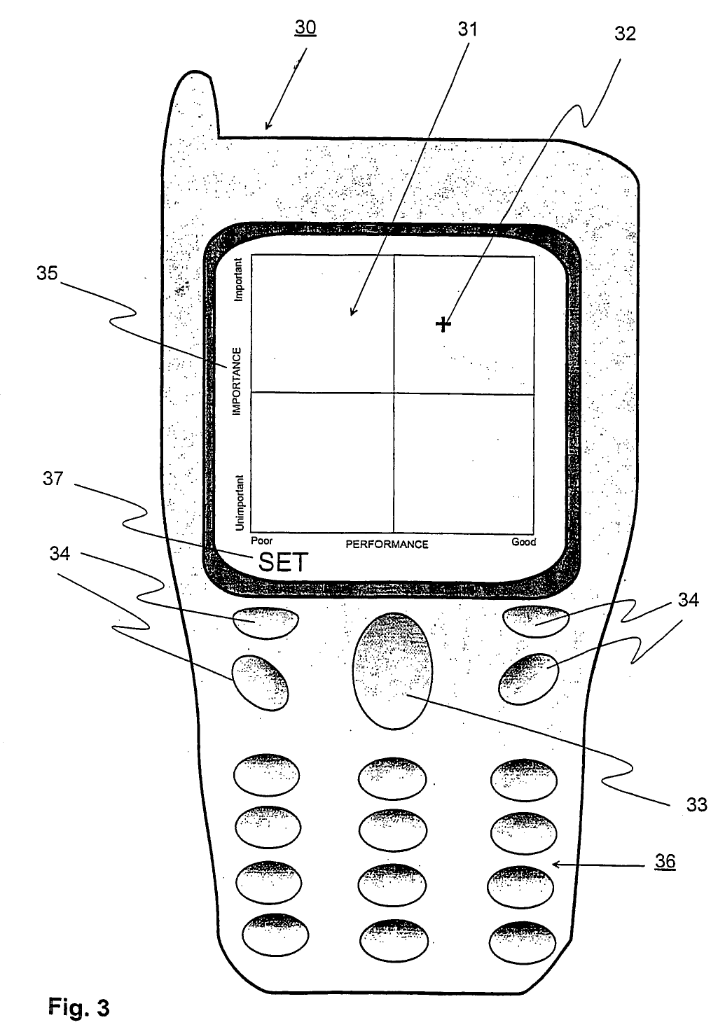

FIG. 3 shows an exemplary presentation of a ZEF evaluation field used in a device/service under evaluation

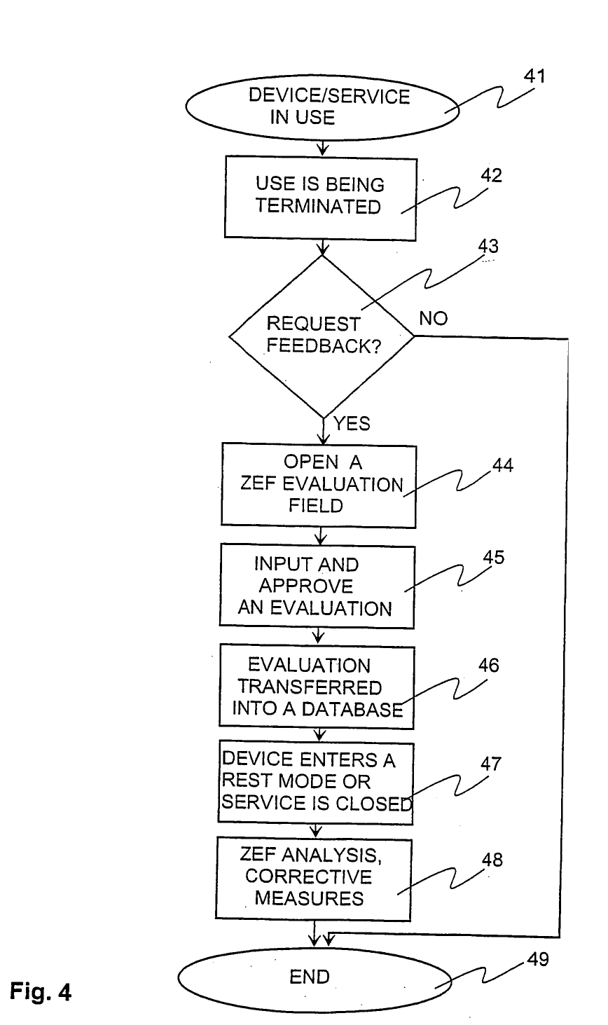

FIG. 4 shows an exemplary flow chart of the main phases of exploiting a method according to the present invention and

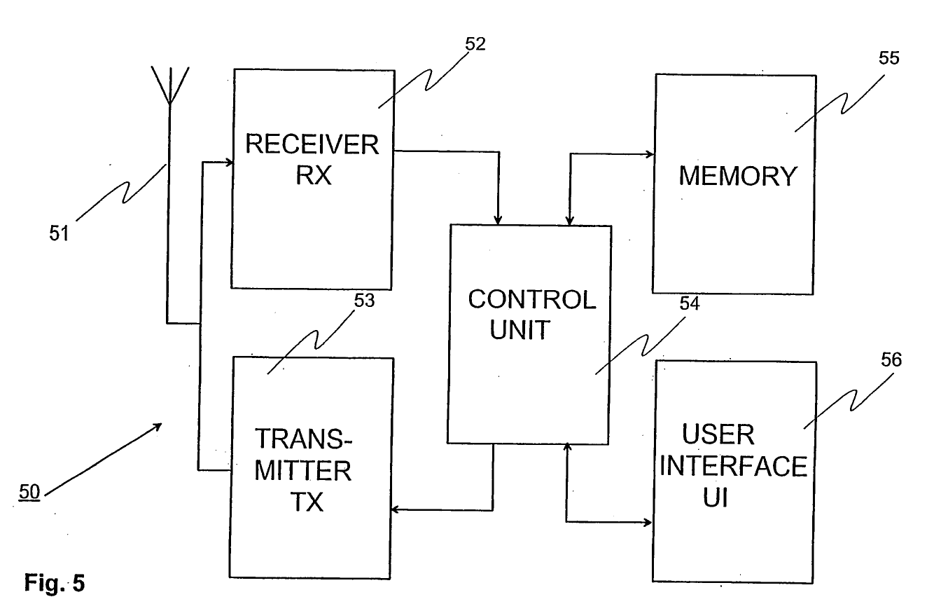

FIG. 5 shows an exemplary presentation of the main components of a cellular network terminal capable of exploiting the present invention.

The summation field/table of the ZEF analysis shown in FIG. 1 is presented above in conjunction with the description of the prior art.

FIGS. 1-5 illustrate a method, an arrangement and a terminal that exploits said method according to the present invention by means of a few advantageous embodiments, which exemplary embodiments employ evaluation and summation fields in accordance with the ZEF method. Naturally, it is possible to replace the ZEF method with another suitable evaluation method and related evaluation fields.

FIG. 2 shows an exemplary presentation of an arrangement where the method according to the present invention can be utilized in acquiring customer feedback. The acquired customer feedback is transferred from a user to a product/device manufacturer or a service provider by means of a data transmission network 20. The data transmission network 20 may be any data transmission network according to the prior art, such as an ordinary telephone network, a GSM network, a GPRS network, an UMTS network, the Internet or any network suitable for data transmission. In practice, the data transmission network 20 is an entity formed by a combination of some of the aforementioned networks. Advantageously it is also possible to connect to said network wirelessly, which is presented by means of references 27a, 27b and 27c in FIG. 2.

A provider of a product/device or service is also connected to the data transmission network 20 by means of his own server SRV 21. Advantageously the server SRV 21 has a fixed connection 29a to the data transmission network 20. A database device 22, into which information received from feedback and analyses of the feedback are stored, is advantageously connected to the server SRV 21 by means of a second fixed connection 29b. One or several devices 23 capable of displaying the results of analysis, such as a PC in the example presented in FIG. 2, are advantageously connected to the database device 22. If it is possible to isolate user groups from the user feedback on the basis of age, sex, financial standing, geographical location or some other aspect of interest to the manufacturer/service provider, the information of each such user group can be displayed simultaneously on its own display in real time.

Before evaluation is taken into use, an evaluation field, for example a ZEF evaluation field, suitably applied to each case, needs to be created for the user-supplied feedback in the server SRV 21. In this exemplary case the evaluation field in server SRV 21 and the evaluation field available in the user's device 24b, 26 or after the user has exploited a service 25 must naturally correspond to each other. Thus, these two sub-areas related to the user evaluation must be created before a new product or service is released onto the market.

Reference 24b in FIG. 2 presents a cellular network terminal from which feedback about its functionality is desired by means of the method according to the present invention. Software means for gathering feedback, for example, according to the ZEF process, at points in time deemed important by the terminal's manufacturer are stored in said terminal 24b. One such point in time is the first session of use of a device or an application added to it. It is possible to add an application to the device which the user of the device can start up whenever he desires and thereby provide an evaluation of the usability of the device. At points of time other than the aforementioned feedback request points in time, the terminal 24b functions according to the prior art and the feedback process is not active and therefore in no way affects the use of the device.

Reference 24b also represents other such devices, not only cellular network terminals, which by themselves are capable of making a connection and creating a data transmission connection to a data transmission network 20 for feedback purposes. Such devices are, for example, personal computers, palm computers, various game consoles or digital TVs capable of bi-directional communication. Such a device must, however, contain a possibility to use and display a graphical user interface for the purpose of giving feedback information.

Reference 25 presents a service function, which upon being exploited a device is used with which it is possible to give real-time feedback to a provider of said service. For example, home pages on the Internet are one possible place for gathering feedback. Likewise, various purchasing and payment events that take place on information networks are examples of services about which it is possible to acquire feedback by means of the method according to the present invention. In service applications, gathering feedback according to the present invention, for example, with the ZEF process, advantageously starts when the user wishes to close the service he is using. In such a case the user is offered a possibility to provide feedback on a 2D or 3D evaluation field before the service is finally closed.

Reference 26 in FIG. 2 presents a device which itself does not include means by which it can connect to a data transmission network 20. However, numerous different technologies of the prior art are known, for example, Bluetooth or infrared technology, with which it is possible to create short range radio networks in which various devices can become networked and exchange information among themselves. Said radio network between devices is illustrated by reference 28.

Thus, the example in FIG. 2 contains a device 26, which is turned on or used the first time. When its use is being terminated by closing the device or by switching the power off, it sends a message regarding termination of first use, for example, by means of a Bluetooth connection 28. At the same time an evaluation field, for example, a ZEF evaluation field, stored by a manufacturer in the device 26, is transferred into the Bluetooth network 28. If the user of the device 26 possesses a cellular network terminal 24a which is also able to connect to said Bluetooth network 28, a message sent by the device 26 requesting an evaluation is transferred to said terminal 24a. Advantageously said evaluation request automatically opens on the display of the terminal 24a the evaluation field which the terminal 24a received from the device 26. The user makes an evaluation and by pressing one key causes the evaluation to be transferred via the data transmission network 20 into a database 22 of the manufacturer of the device 26. At the same time the terminal 24a closes the evaluation display used in the evaluation and the terminal returns to its characteristic rest mode.

FIG. 3 shows an exemplary presentation of a cellular network terminal 30. Advantageously the terminal 30 comprises a graphical display 35, alphanumerical keys 36, one or several software function keys 34 and a four-way key 33.

In the example in FIG. 3 a ZEF evaluation field 31 (2D evaluation) is brought onto the display of the terminal 30. In the example in FIG. 3 the dimensions/axes of the ZEF evaluation field 31 are the same as those presented previously in conjunction with FIG. 1. Likewise, the evaluation criteria are the same as the criteria used in FIG. 1. However, the example in FIG. 3 in no way limits the possibility of using in ZEF evaluation field 31 other dimensions and evaluation criteria that are more suitable in certain uses and applications. The evaluation axes may also be replaced by, for example, graphical symbols or various color codes known to the user.

The ZEF evaluation field 31 is advantageously stored in the terminal 30 in conjunction with its manufacture. It is also possible to store the evaluation field 31 in the terminal 30 in conjunction with the purchase/storage of an application. In both cases the ZEF evaluation field appears on the display of the terminal 30 when the terminal is being closed after the first use. In many terminals, before the power is finally turned off in conjunction with closing, a confirmation request appears on the display asking for confirmation that the device truly is to be turned off. In the method according to the present invention, said confirmation request is replaced by a ZEF evaluation display in conjunction with the first use of the device/application or whenever the user himself wishes to provide feedback.

In the example presented in FIG. 3 the user has moved the cursor 32 used in the evaluation to a desired position on the ZEF display. Advantageously the user can change the position of the cursor, for example, by employing a four-way key 33 presented in the terminal 30 in FIG. 3. Alternatively the cursor 32 can be moved by means of software keys 34, alphanumerical keys 36 or also with a separate pointer or similar means. When the cursor 32 is at the desired position on the ZEF evaluation field 31, the user presses a software SET key 37 shown in the example in FIG. 3. Pressing the software SET key 37 closes the ZEF evaluation field 31, sends the evaluation result via the wireless connection 27a to the data transmission network 20, from where it is transferred to the manufacturer's database 22 and where it is currently combined with other possibly received feedback. If the data of the user of the terminal 30 are known by the manufacturer, the manufacturer may combine the feedback analysis information and the user data in a manner desired by the manufacturer. When the evaluation result has been sent successfully, the terminal 30 enters its characteristic rest mode.

FIG. 4 shows an exemplary flow chart of an exploitation of an arrangement according to the present invention in conjunction with the first use or market entry of a new product. The initial situation may also be the first time or times that a new application loaded into a device is used. To facilitate the explanation of the flow chart, the terminal 30 presented in conjunction with FIG. 3 and the functional components explained in the same conjunction and the ZEF process as an exemplary information gathering and analysis method, are employed as aids.

In the initial situation 41 the device or service has been in use the first time. In phase 42 the user wishes to close the device or exit from a certain service. This activates a check routine 43 programmed into the device 24b, 26, 30 or service 25. In phase 43 a check is made to determine whether or not feedback is to be requested from the user. If the answer to the question is NO, the device enters its characteristic rest mode or the service is closed. Phase 49 follows.

Advantageously phase 43 comprises several different functional alternatives which are of interest to the manufacturer/service provider. Feedback may be requested only after the first session of use. Alternatively, feedback is requested after the first few sessions of use. Feedback may also be requested after a certain number of sessions of use has occurred or after a certain period of time has elapsed after the first session of use. Advantageously the user may also be given the possibility to provide feedback whenever he wishes. It is also possible to transfer a programmable command into the device via the data transmission network 20 at a later time, which command activates a feedback request upon fulfillment of a decision criterion.

If the answer in phase 43 is YES, a ZEF evaluation field 31 is opened on the display 35 of the device 30 in phase 44. If device 26 is being used, which does not have means for connecting to the actual data transmission network 20, a wireless connection 28 can be created from said device to a device 24a that is capable of creating a data transmission connection 27b to the data transmission network 20 during phase 44. In that case the ZEF evaluation field is opened in said second device 24b.

In phase 45 the user moves the cursor 32 to the desired position on the ZEF evaluation field 31. By pressing the software SET key 37 the user approves the evaluation. Providing a single evaluation and feedback takes approximately 2-3 seconds. In the method according to the present invention it is possible to ask the user to evaluate several consecutive evaluation points that differ from each other, if this is deemed necessary. The evaluation result is transferred from the device 30 via the data transmission network 20 into a database 22 in phase 46.

In phase 47 the device closes/enters a rest state or the service is terminated. After this if the user wishes to use the device or service again, he must open/connect to the service again from the beginning.

The ZEF process's second analysis of the information in the database 22 is completed in phase 48. Said second analysis can also be called a feedback analysis. Advantageously the second analysis can be updated after each feedback is received. Especially in conjunction with the introduction of a new product to the market, this type of quick feedback analysis makes it possible initiate quick corrective measures if the result of the second analysis indicates the presence of such problems that the product or service needs to be repaired.

From the standpoint of an individual user, the analysis process according to the present invention ends in phase 49.

FIG. 5 shows an exemplary presentation of the main components of a wireless terminal 50 that is capable of connecting to an arrangement according to the present invention. The terminal 50 employs an antenna 51 when transmitting and receiving messages. Reference 52 presents means that form a receiver RX, with which the wireless terminal 50 receives messages from the data transmission network 20. The receiver RX comprises means according to the prior art for all received messages. Advantageously the receiver RX also comprises means for receiving a message sent via an infrared or Bluetooth connection.

Reference 53 presents means that form a transmitter TX of the wireless terminal 50. The transmitter means 53 perform all the necessary signal processing measures to the signal being sent, which are required when operating with a cellular network 20.

From the standpoint of exploiting the present invention, an important operating unit of the terminal is the control unit 54, which controls the operation of the terminal 50. It controls the operation of all the main components belonging to the terminal 50. It controls both reception and transmission. It is also used to control a user interface UI 56 and memory 55. In the method according to the present invention the control unit 54 specifies when a feedback request according to the present invention is made to the user. It also sets the display belonging to the user interface UI 56 of the terminal 50 into the display state required by the evaluation field, for example, into the display state in accordance with the ZEF process shown in FIG. 3.

The software application required in the operation of the control unit 54, in completing evaluations according to the present invention, and in transmitting, is advantageously located in a memory 55 of the terminal 50. The application can be stored in the memory 55 either in conjunction with the manufacture of the device or it can be transferred there via the data transmission network 20 at the desired time.

On the data transmission network 20 side the operation according to the present invention does not require methods that differ from the prior art. The software analysis application, for example the ZEF analysis application, required in applying the present invention, is advantageously stored in a server SRV 21. If feedback is desired, for example, about a certain service of a network provider, server SRV 21 can advantageously be part of an existing functional element of a cellular network.

Certain advantageous embodiments according to the present invention are described above. The present invention is not limited to the described embodiments, they are only intended as applications in principle of the present invention. The method and arrangement according to the present invention are not limited to the ZEF method employed as an aid in presenting the exemplary embodiments. The inventive idea may be applied in numerous ways within the scope defined by the attached claims.

1. A method for producing real-time user feedback about a product or service, in which method a user provides feedback on an at least two-dimensional evaluation field (31), characterized in that said evaluation field (31) becomes activated in a device exploited by said user upon fulfillment of a specific criterion of use (43) and feedback on said two-dimensional evaluation field is transferred (46) via a data transmission network (20) into a database (22) of a product/service provider for completion of feedback analysis.

2. The feedback evaluation method according to claim 1, characterized in that it comprises:
a phase (42) in which notification of termination of the use of the product/service is given,
a phase (43) in which a decision is made whether or not to request user feedback about the product/service used,
a phase (44) in which an at least two-dimensional evaluation field is opened for evaluation on a display (35) of a device (30) in the possession of the user before the device/service is finally closed,
a phase (45) in which the user provides his evaluation on said evaluation field (31) by means of a cursor (32),
a phase (46) in which the provided evaluation (32) is transferred into the database (22) of the manufacturer/service provider,
a phase (47) in which the device/service being used (24b, 25, 26, 30) is closed and
a phase (48) in which a feedback analysis of all user evaluations stored in the database (22) is completed.

3. The feedback evaluation method according to claim 2, characterized in that said feedback analysis (48) comprises:
a phase in which the at least two-dimensional evaluation fields (31) stored in the database (22) are combined and the combined values are standardized into a summation table by means of a software application located in a server (21), after which said summation table is stored in the database (22) and
a phase in which said summation table is presented in real time in order to evaluate the functionality of the product/service.

4. The feedback evaluation method according to claim 2, characterized in that in phase (43) a decision is made to request user feedback about the product/service only when the first session of use of the product/service is being terminated.

5. The feedback evaluation method according to claim 2, characterized in that in phase (43) a decision is made to request user feedback about the product/service when at least two sessions of use of the product/service are being terminated.

6. The feedback evaluation method according to claim 2, characterized in that in phase (43) a decision is made to request user feedback about the product/service when specific sessions of use of the product/service are being terminated or when a specific period of time has elapsed since the first session of use or when the user so requests.

7. A feedback arrangement, which comprises an at least two-dimensional evaluation field (31) for providing feedback about a product/service (24a, 25, 26), means for analyzing said feedback (21, 22, 23), a data transmission network (20) and means for connecting the product/service and feedback analysis means in a data transmission network (20), characterized in that said evaluation field (31) is realized using software means contained in the product/service, which means are arranged to become activated in the device/service utilized by a user upon fulfillment of a specific criterion of use (43) and that the feedback on the at least two-dimensional evaluation field (31) is arranged to be transferred (46) via the data transmission network (20) into a product/service provider's feedback information analysis means (21, 22, 23) for completion of feedback analysis.

8. The feedback arrangement according to claim 7, characterized in that the means for analyzing the feedback information comprise
means for storing the feedback information (31) in a product/service provider's database (22),
means for combining individual feedback information (31) with other provided feedback to produce aggregate feedback,
means for standardizing said aggregate feedback into a summation table by means of a software application contained in a server (21),
means for storing said summation table in the database (22) and
means (23) for employing the summation table to present the feedback depicting the functionality of the product/service.

9. The feedback arrangement according to claim 8, characterized in that the means for analyzing the feedback information also comprise means for processing the feedback information by customer segment.

10. The feedback arrangement according to claim 7, characterized in that said feedback arrangement is arranged to become activated only when the first session of use of the product/service is being terminated.

11. The feedback arrangement according to claim 7, characterized in that said feedback arrangement is arranged to become activated when at least two sessions of use of the product/service are being terminated.

12. The feedback arrangement according to claim 7, characterized in that said feedback arrangement is arranged to become activated when specific sessions of use of the product/service are fulfilled or when a specific period of time has elapsed since the first session of use or when the user so requests.

13. The feedback arrangement according to claim 7, characterized in that said at least two-dimensional evaluation field (31) is stored in the product/service in conjunction with its manufacture.

14. The feedback arrangement according to claim 7, characterized in that said at least two-dimensional evaluation field (31) is arranged to be stored in the product/service as a software application transferred via the data transmission network (20).

15. A cellular network terminal (30, 50), which comprises transmission and reception means (51, 52, 53), a control unit (54), a memory (55) and a user interface (56), characterized in that it also comprises means for activating and completing an at least two-dimensional feedback questionnaire and for sending information into a specific database (22) upon fulfillment of a specific criterion of use (43).

16. The terminal according to claim 15, characterized in that the means for activating and completing said at least two-dimensional feedback questionnaire and sending said information are arranged to become activated only when the first session of use of the terminal (30, 50) is being terminated.

17. The terminal according to claim 15, characterized in that the means for activating and completing said at least two-dimensional feedback questionnaire and sending said information are arranged to become activated when at least the first two sessions of use of the terminal (30, 50) are being terminated.

18. The terminal according to claim 15, characterized in that the means for activating and completing said at least two-dimensional feedback questionnaire and sending said information are arranged to become activated in conjunction with closing of the terminal when specific sessions of use are fulfilled or when a specific period of time has elapsed since the first session of use of the terminal (30, 50) or when the user so requests.

19. The cellular network terminal according to claim 15, characterized in that the means for activating said at least two-dimensional feedback questionnaire comprise a software application stored in the memory (55) of the terminal (30, 50).

20. The cellular network terminal according to claim 19, characterized in that said software application is stored in the memory (55) of the terminal (30, 50) in conjunction with its manufacture.

21. The cellular network terminal according to claim 19, characterized in that said software application is stored in the memory (55) of the terminal (30, 50) during use of the terminal.

22. The cellular network terminal according to claim 15, characterized in that said means for completing the feedback questionnaire comprise:
an at least two-dimensional evaluation field (31) and a related cursor (32), which are arranged to be presented on a display of the terminal (30, 50),
means (33, 36) for changing the position of the cursor (32) on said evaluation field (31) and
means (37) for approving the evaluation.

23. The cellular network terminal according to claim 22, characterized in that the means for approving the evaluation comprise one of the following: a software key (34) or an alphanumerical key (36).

24. The cellular network terminal according to claim 22, characterized in that the at least two-dimensional evaluation field (31) comprises one of the following alternatives:
two evaluation axes perpendicular to each other and related evaluation criteria or
graphical symbols or color codes depicting an evaluated feature in two evaluated dimensions.

25. The cellular network terminal according to claim 15, characterized in that it also comprises:
means for connecting to a local radio network (28) and
means for receiving a message from a second device (26) via said radio network (28), which message is arranged to activate an application located in the terminal (30, 50) that implements a feedback questionnaire for the purpose of providing feedback from the second device (26).
